(19) United States
(12) Patent Application Publication
(10) Pub. No.: US 2012/0116724 A1
(43) Pub. Date: May 10, 2012

(54) SENSOR DATA TRANSMISSION FREQUENCY CONTROLLER USING SENSOR SITUATION INFORMATION

(75) Inventors: Nobuhiro TAKARA, Saitama (JP); Teruaki TAKIGAHIRA, Saitama (JP)

(73) Assignee: OKI ELECTRIC INDUSTRY CO., LTD., Tokyo (JP)

(21) Appl. No.: 13/244,228

(22) Filed: Sep. 23, 2011

(30) Foreign Application Priority Data
Nov. 8, 2010 (JP) 2010-250010

(51) Int. Cl. G06F 15/00

(52) U.S. Cl. 702/188

(57) ABSTRACT

A transmission frequency controller includes situation information storage and a transmission frequency changing director. The storage stores respective situation information of sensors, which information clarifies the association of cooperating sensor with a subject detecting sensor. The director refers to the situation information in accordance with the subject detecting data from the subject detecting sensor to confirm the cooperating sensors cooperating with the subject detecting sensor and directs change of a data transmission frequency to the subject detecting sensor and the cooperating sensors. Thus, it is possible to acquire only the needed sensor data and decrease the traffic on the entire network.

### BACKGROUND OF THE INVENTION

1. Field of the Invention

The present invention relates to a transmission frequency controller for controlling a transmission frequency or rate of sensor data, for instance, which can be applied in a telecommunications network system, such as a sensor network or a home network comprising a plurality of sensors.

2. Description of the Background Art

In recent years, it requires that a plurality of communication devices comprising a sensor or sensor devices are dispersively located, a controller intermittently collects sensor data from the plurality of communication devices and the collected sensor data is used for providing different services.

Conventionally, for transmitting data in a system comprising a plurality of sensors, a data collection controller and a service provider, there are some data transmission modes, such as an event-notification mode, where the sensor automatically transmits data, and a polling mode, where the sensor receives polling, and in response thereto transfers data to the controller.

Japanese patent laid-open publication No. 2006-325118 discloses a monitored data collecting system which uses the event-notification mode and polling mode of data transmissions to acquire monitored data to a monitoring device from another device to be monitored. In the system of this publication, when a process load of the monitoring device as a controller increases, to prevent the reception of the monitored data from disabling, the data transmission mode is switched according to the congestion state of the monitoring device.

In addition to the technique disclosed in the above-mentioned publication, there are some conventional ways for switching data transmission mode. For instance, in one switching way, when the event notification from the sensor device does not occur, a polling mode is applied. Another switching way switches between the event-notification mode and polling mode according to data occurring frequency or response speed.

As mentioned above, the technique of the publication or any other conventional way is adapted to switch between the event-notification mode and polling mode depending on an indicator being a physical value, such as traffic between the sensor device and controller or process load of the sensor device and/or controller.

However, the conventional ways only mechanically switch the data transmission mode depending on the traffic or controller's processing volume, and do not consider semantic characteristics of each sensor, such as a sensor property, a situation of a sensor location or a role of the sensor.

For example, as kinds of the sensors, there are a motion sensor, a temperature sensor, a humidity sensor, an electric power sensor and others. Required data for a service to be provided is not always one kind and it may be necessary to monitor many kinds of data. A monitoring manner of data may be changed according to situation of the service, e.g. it is necessary to monitor data during a long or short period or in a moment. To provide detailed or sophisticated service, an interval for transmitting sensor data may be changed, e.g. the transmitting interval in a predetermined period is shortened to acquire more data. It is thus preferable to acquire data in a suitable manner for purposes of data monitoring and service.

The conventional ways have a problem that it is impossible to suitably acquire required data for a primary purpose according to the semantic characteristic of each sensor.

### SUMMARY OF THE INVENTION

It is an object of the present invention to provide a sensor data transmission frequency controller in a system of collecting data from a plurality of sensor devices for actualize the suitable acquirement of data to be primarily acquired according to a purpose without increasing traffic over the entire network.

In accordance with the present invention, a transmission frequency controller for controlling transmission frequencies of sensor data, at which frequencies a plurality of sensor devices respectively transmit sensed data, comprises situation information storage and a transmission frequency changing director. The storage stores respective situation information of the plurality of sensor devices, which consist of subject detecting sensor devices of detecting a subject and one or more cooperating sensor devices cooperating with the subject detecting sensor device, which information clarifies an association of the cooperating sensor device with the subject detecting sensor device. The director directs change of a data transmission frequency in accordance with the subject detecting data received from the subject detecting sensor device to the subject detecting sensor device confirmed by referring to the situation information and the cooperating sensor device cooperating with the subject detecting sensor device.

In accordance with the present invention, in the system of collecting data from a plurality of sensor devices, the sensor data transmission frequency controller controls a frequency or rate of data transmission from each sensor device, thereby suitably acquiring the data to be primarily acquired according to the purpose without increasing traffic on the entire network.

The inventive concept disclosed in the application may also be defined in ways other than in the claims presented below. The inventive concept may consist of several separate inventions particularly if the invention is considered in light of explicit or implicit subtasks or from the point of view of advantages achieved. In such a case, some of the attributes included in the claims may be superfluous from the point of view of separate inventive concepts. Within the framework of the basic inventive concept, features of different embodiments are applicable in connection with other embodiments.

### BRIEF DESCRIPTION OF THE DRAWINGS

The objects and features of the present invention will become more apparent from consideration of the following detailed description taken in conjunction with the accompanying drawings in which:

FIG. 1 is a schematic system diagram showing a network including a plurality of sensor devices and a sensor data transmission frequency controller in accordance with a preferred embodiment of the present invention;

FIG. 2 is a schematic block diagram showing the sensor data transmission frequency controller of the preferred embodiment;

FIG. 3 schematically shows sensor situation information of the preferred embodiment;

FIG. 4 is a schematic block diagram showing a sensor controller of the preferred embodiment;

FIG. 5 schematically shows communication control information of the preferred embodiment;

FIG. 6 is a schematic block diagram showing a sensor device of the preferred embodiment;

FIG. 7 schematically shows locations of the sensor devices on a home network of the preferred embodiment; and

FIG. 8 is a sequence chart useful for understanding the process of controlling a transmission frequency of sensor data over the network of the preferred embodiment.

### DESCRIPTION OF THE PREFERRED EMBODIMENT

With reference to the accompanying drawings, a preferred embodiment of a sensor data transmission frequency controller according to the present invention will be described below.

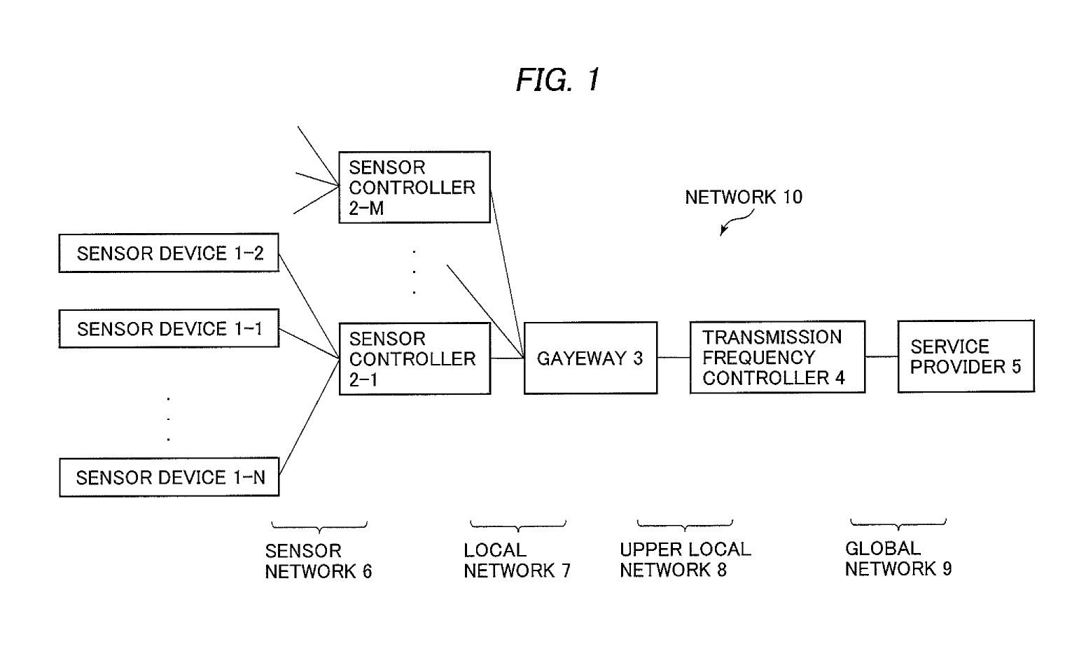

FIG. 1 is a schematic system diagram showing a telecommunications network including a sensor data transmission frequency controller of the preferred embodiment. In the figure, the network 10 according to the preferred embodiment includes a plurality of sensor controllers 2-1 to 2-M, where N is a natural number, a plurality of sensor devices 1-1 to 1-N, where N is a natural number, connected with one sensor controller, a gateway 3, the sensor data transmission frequency controller 4, which may hereinafter be called simply as a transmission frequency controller, and a service provider 5. FIG. 1 specifically illustrates the plurality of sensor devices 1-1 to 1-N connected with the sensor controller 2-1 as an example, but the respective sensor controllers may similarly connect with a variety of sensor devices although not shown.

FIG. 1 illustrates that the network 10 includes a plurality sub-networks, such as a sensor network 6 between the sensor devices and sensor controllers, a local network 7 between the sensor controllers and gateway 3, an upper local network 8 between the gateway 3 and transmission frequency controller 4 and a global network 9 between the transmission frequency controller 4 and service provider 5.

The sensor network 6 is constructed regardless of being commercial or not, as long as the sensor controllers can control its network, without another restriction.

The sensor device 1-n, where n is an integer from 1 to N, is adapted to communicate with a predetermined sensor. The sensor device 1-n can transmit sensed data on the sensor network 6 to the sensor controller 2-1.

The sensor device 1-n is controlled by the sensor controller 2-1 so that the communication control of the device is carried out, e.g. to determine a data transmission mode and a transmitting interval. The data transmission mode is not restricted but may be selected from different modes. The preferred embodiment is directed to a case where an event-notification mode and a polling mode according to polling from the sensor controller 2-1 are utilized.

The sensor device 1-n also can apply one of different kinds of the sensors in accordance with a service to be provided. For instance, as kinds of the sensors, there are a temperature sensor, a humidity sensor, a temperature and humidity sensor, an illumination sensor, a motion sensor, an electric power sensor and others. The sensor device 1-n is located at a suitable position for the kind of the applied sensor and the purpose of the service.

The sensor controller 2-m, where m is an integer 1 from 1 to M, is adapted to communicate with the sensor devices 1-n, thereby controlling the communication on the sensor network 6. The sensor controller 2-m transmits received data from the sensor device 1-n over the local network 7 to the gateway 3.

The sensor controller 2-m also receives a control directing signal via the gateway 3 from the transmission frequency controller 4, and then, switches the transmission mode of each sensor device 1-n being communicable with the controller 2-m and changes configurations of the transmission mode on the basis of the control directing signal.

The gateway 3 is arranged between the local network 7 and upper local network 8 to receive data from the sensor controller 2-m or the transmission frequency controller 4 and to transmit the received data to a destination.

The sensor data transmission frequency controller 4 is adapted to control a transmission frequency or rate of sensor data. The transmission frequency controller 4 can receive data over the upper local network 8 from the gateway 3, and then, recognize the objective situation on the basis of the received data. The controller 4 moreover performs a predetermined process on the basis of the received data as raw data to obtain processed data, and then, transmits the received data and processed data on the global network 9 to the service provider 5.

The transmission frequency controller 4 also directs each sensor device 1-n to switch the transmission mode and change its configurations in accordance with the monitored current situation. The controller 4 carries out the direction of the switch of the transmission mode and change of its configurations to the sensor controller 2-m connected with each sensor device 1-n. Since the controller 4 has information about the sensor controller 2-m connected with each sensor device 1-n, the controller 4 can identify the sensor controller 2-m, connected for the sensor device 1-n to which the switch and change are to be directed, and then, carry out the direction to the identified sensor controller 2-m.

To simplify the description, FIG. 1 illustrates that one service provider 5 is arranged, i.e. that the transmission frequency controller 4 collects data with regard to one service. The controller 4 however may collect data with regard to each of a plurality of services. The controller 4 then may recognize the suitable situation for the purpose of each service and perform the data processing and direction to the sensor controller 2-m in accordance with that situation.

The service provider 5 is adapted to provide a predetermined service by using data received over the global network 9 from the transmission frequency controller 4.

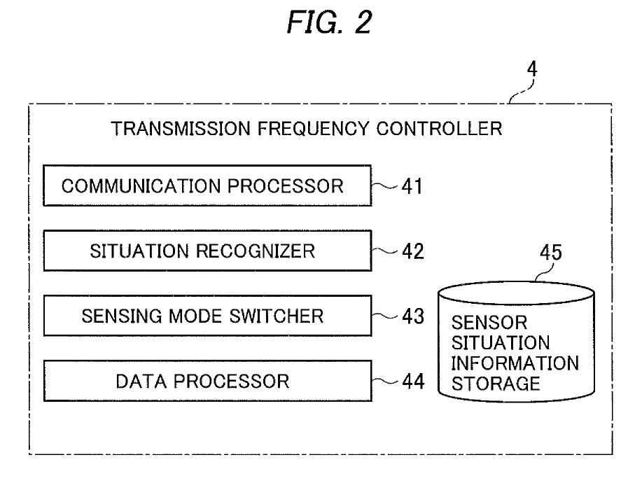

FIG. 2 is a schematic block diagram showing the sensor data transmission frequency controller 4 of the preferred embodiment. As shown in the figure, the transmission frequency controller 4 comprises a communication processor 41, a situation recognizes 42, a sensing mode switcher 43, a data processor 44 and sensor situation information storage 45.

The communication processor 41 is adapted to receive and transmit data between the upper local and global networks 8 and 9.

The sensor situation information storage 45 is adapted to store sensor situation information about the situation of each sensor device 1-n, which information is related to a service to be provided.

The sensor situation information may include information indicating characteristic meaning and situation of each sensor in the data collection, such as a kind of the sensor of the sensor device 1-n in question, a role of the present sensor in the service and a location of the present sensor, the relationship of the present sensor with other sensor devices 1-n, and the sensor controller controlling the communication of the present sensor and others.

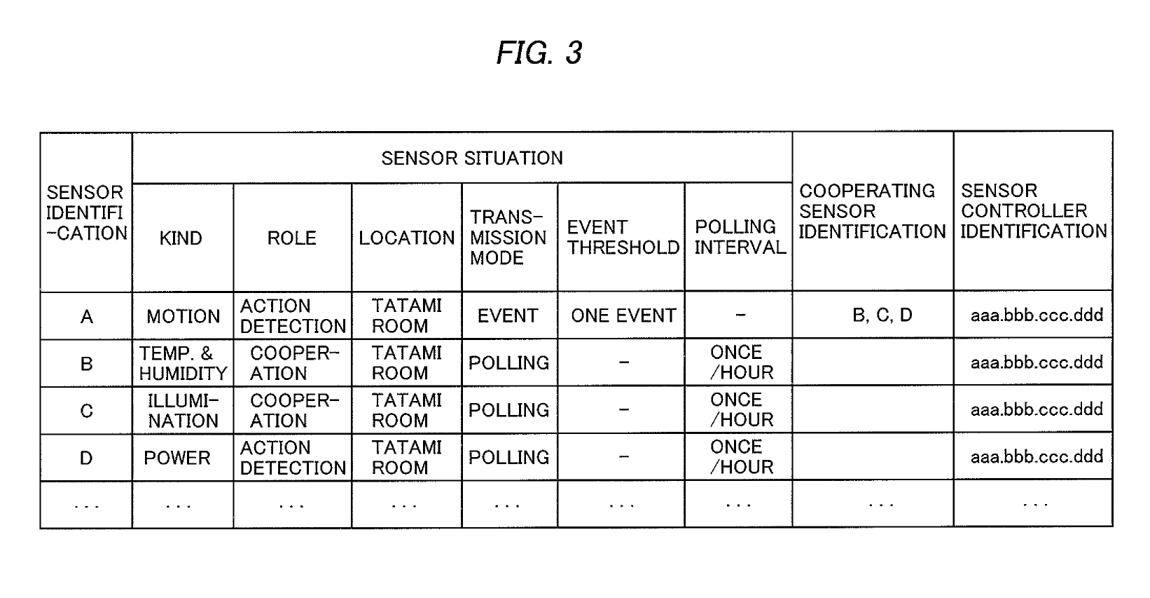

FIG. 3 schematically shows examples of items of information stored in the sensor situation information storage 45. For instance, the items of FIG. 3 are cited on the supposition that the service needs to monitor temperature, humidity, illumination and electric power data when entrance into a room by someone is sensed.

As shown in FIG. 3, as super-items of sensor situation information, there are “sensor identification”, “situation information”, “cooperating sensor identification” and “sensor controller identification”. As examples of sub-items of the “situation information”, there are “kind”, “role”, “location”, “transmission mode”, “event threshold” and “polling interval” or “transmitting interval.”

The “sensor identification” is information for identifying each sensor device 1-n, such as identification (ID) number and address information. The “kind” is a kind of the sensor included in each sensor device 1-n, such as a motion sensor, a temperature and humidity sensor, an illumination sensor or an electric power sensor.

The “role” is an item of clarifying the meaning and role of each sensor in relation to the purpose of monitoring data. The meaning and role of each sensor clarified by the “role” depend on what the purposes of monitoring data and providing service are, and therefore may be suitably determined in accordance with the purposes.

The “location” is an item of indicating a position at which a sensor device 1-n is located. FIG. 3 illustrates a case where the sensors are arranged into a Japanese-style, e.g. tatami, room in a house, but the item of the “location” may not be restricted to this case. The item may be described as a more detailed position, such as “the side of an air-conditioner in a tatami room”, “the neighborhood of an electricity outlet in a tatami room” or others. For instance, when several similar sensors are arranged into one room, the items of the sensors can be described so as to decide where each sensor is arranged, thereby distinguishing the positions of the sensors from each other.

The “transmission mode” is a current mode of transmitting data by the sensor device 1-n in question having the present sensor. The “event threshold” is a threshold used for the event notification during the event-notification mode is selected. The “polling interval” or “transmitting interval” is a data transmitting interval during the polling mode is selected. As the items of the “event threshold” and the “polling interval” or “transmitting interval”, a data transmission frequency is described. For instance, by the “event threshold”, it is possible to manage the number of events occurring until data is transmitted, wherein as the number of events decreases, the data transmission frequency increases. By the “polling interval” or “transmitting interval”, the number of pollings per unit time is managed as, e.g. “once per minute” or “once per hour”. The items also may be managed to determine in advance within the range of the data transmission frequency from “1 (low frequency)” to “5 (high frequency)”.

The “cooperating sensor identification” is information for identifying one or more sensors arranged to cooperate with the present sensor in relation to the purpose of monitoring data or others. The “sensor controller identification” is information for identifying the sensor controller controlling the communication with the present sensor device 1-n, such as address information.

For example, as a sensor used in the supposed service illustrated FIG. 3, there are sensors being sensitive to the action of a subject or person to be sensed when active. Such a sensor is often hereinafter called an action detecting sensor. In the figure, the “role” of this sensor is described as “action detection”. As an example of the action detecting sensor, there are a motion sensor of directly sensing a person and an electric power sensor of indirectly sensing a person by detecting variation of electric energy when a person in a room uses electrical home appliances or measuring the electric energy of the electrical home appliance connected to a mains electricity outlet. The unavailable sensor as an action detecting sensor is a sensor being not able to sense a person regardless of directly or indirectly, such as a temperature and humidity sensor.

In addition, there are sensors monitoring objective data cooperating with the detection of the subject by the action detecting sensor. Such a sensor is often hereinafter called a cooperating sensor or a cooperating sensors' group. In FIG. 3, the “role” of this sensor is described as “cooperation”. For instance in a service of monitoring the operating status of an air-conditioner, this sensor may be adapted to monitor room situation in accordance with the detection of a person in the room. In the example as shown in the figure, as the cooperating sensor cooperating with the motion sensor, the temperature and humidity, illumination and electric power sensors may be utilized. Although the power sensor has the role as an action detecting sensor, considering the purpose of monitoring the operating status of the air-conditioner, the power sensor also may have another role as a cooperating sensor.

The situation recognizer 42 is adapted to refer to the sensor situation information on the basis of received data, thereby recognizing an actual situation. For instance, when the sensor identification included in the received data is correspondent with the sensor identification “A” in FIG. 3, the recognizer recognizes that the sensor data is transmitted from “role: action detecting sensor” in “location: tatami room”. Moreover, after the data from the action detecting sensor is received, when data with the sensor identification “B” or “C” is received, the recognizer can estimate that the sensor data is transmitted from the temperature and humidity or illumination sensor in “location: tatami room” in which a person exists.

The sensing mode switcher 43 is adapted to direct the change of the sensing mode of sensor device 1-n, such as the switch of the transmission mode of sensor device 1-n and change of its configurations, to the sensor controller 2-m on the basis of the situation recognized by the situation recognizer 42. The sensing mode switcher 43 has an operating definition for changing the sensing mode in accordance with the situation and may direct the change of the sensing mode in accordance with the operating definition. For instance, when data with the sensor identification “A” in FIG. 3 is received from the action detecting sensor, the switcher directs to switch the transmission mode of the sensor device from the event-notification mode to the polling mode. Moreover, after the data from the action detecting sensor is received, the switcher directs to shorten the polling interval or to decrease the event threshold so as to increase the data transmission frequencies of the cooperating sensors “B”, “C” and “D” cooperating with the action detecting sensor. Thus, by directing the change of the sensing mode in accordance with the situation, it is possible to decrease the data transmission frequency of the action detecting sensor and to increase the data transmission frequencies of the temperature and humidity and illumination sensors required for monitoring data.

The data processor 44 is adapted to carry out a predetermined process on data received over the upper local network 8 or a data group including the received data. Thus, the processor can process the data to make data required for providing service by the service provider 5 and send the processed data to the service provider 5. The process carried out by the data processor 44 depends on the service. For example, there are totalizing process and statistical process.

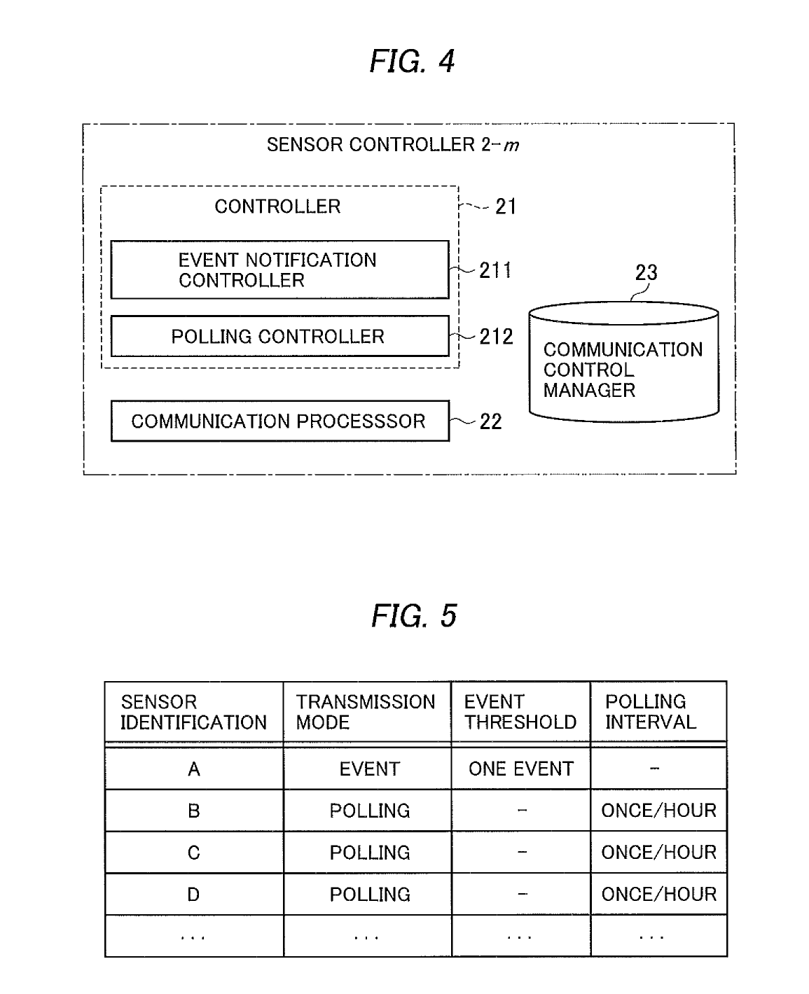

FIG. 4 is a schematic block diagram showing a sensor controller 2-m according to the preferred embodiment. As shown in the figure, the sensor controller 2-m comprises a controller 21, a communication processor 22 and a communication control manager 23.

The communication control manager 23 is adapted to hold and manage the communication control managing information of the sensor devices 1-n communicable with the sensor controller 2-1, on a sensor device-by-sensor device basis.

The communication processor 22 is adapted to receive sensor data from each sensor device 1-n and transmit the received data to the gateway 3. The communication processor 22 also receives a communication control direction to each sensor device 1-n from the transmission frequency controller 4 over the local network 7. The processor 22 then sends the received communication control direction to the controller 21. The transmission frequency controller 4 moreover receives a communication controlling signal to be directed to a sensor device 1-n from the controller and transmits the controlling signal to the sensor device 1-n.

FIG. 5 schematically shows communication control managing information held in the communication control manager 23 according to the preferred embodiment. As shown in the figure, the communication control managing information has items of “sensor identification”, “transmission mode”, “event threshold” and “polling interval” or “transmitting interval”. The items of “sensor identification”, “transmission mode”, “event threshold” and “polling interval” or “transmitting interval” may be similar to the corresponding items in FIG. 3.

The controller 21 is adapted to control communication of each sensor device 1-n in accordance with the communication control direction from the transmission frequency controller 4. The controller 21 receives the communication control direction from the transmission frequency controller 4, and then, refers to the communication control managing information to carry out the switch of the transmission mode of the sensor device 1-n to be directed and change of its configurations.

The controller 21 also comprises an event notification controller 211 and a polling controller 212. When the event notification controller 211 receives the change of the event threshold used for data transmission from the transmission frequency controller 4, the event notification controller 211 notifies the event threshold to the directed sensor device 1-n. When the polling controller 212 receives the change of the polling interval used for data transmission from the transmission frequency controller 4, the polling controller 212 transmits polling to the directed sensor device 1-n at the changed interval.

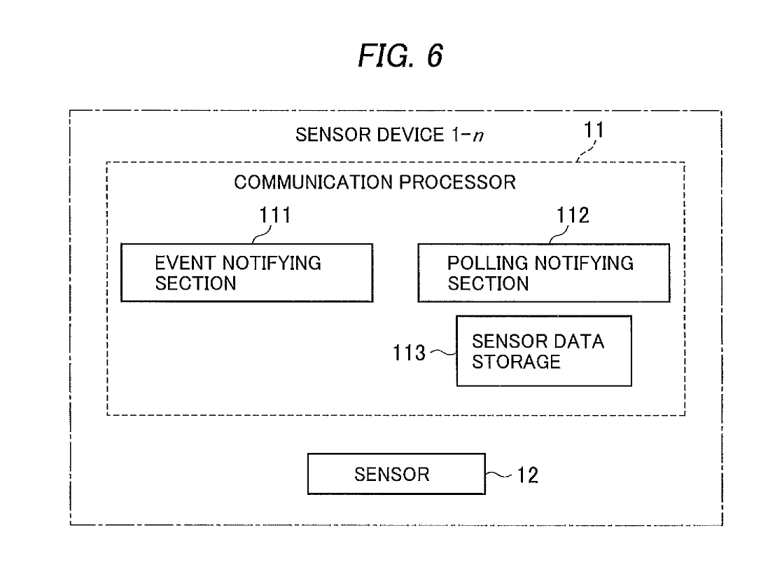

FIG. 6 is a schematic block diagram showing the sensor device 1-n according to the preferred embodiment. It is to be noted that the sensor devices 1-1 though 1-N may be the same in configuration as each other. As shown in the figure, the sensor device 1-n comprises a communication processor 11 and a sensor 12. The communication processor 11 comprises an event notifying section 111, a polling notifying section 112 and sensor data storage 113.

The communication processor 11 receives a direction from the sensor controller 2-m to switch the use of the event or polling notifying section 111 or 112 in accordance with the direction and transmits the sensor data to the sensor controller 2-m by means of the switched section.

The event notifying section 111 operates, when an event occurs, to transmit data sensed by the sensor 12 in accordance with a predetermined event threshold controlled by the sensor controller 2-m.

The polling notifying section 112 receives the polling from the sensor controller 2-m and transmits data sensed by the sensor 12 or stored in the sensor data storage 113 in response to the reception.

The sensor 12 is adapted to produce the sensor data. The sensor data storage 113 is adapted to temporarily store the data sensed by the sensor 12.

Now, the operation of controlling the transmission frequency of sensor data on the network 10 according to the preferred embodiment will be described with reference to the figures.

The preferred embodiment will be illustrated in a case of providing a service of monitoring the operating status of an air-conditioner in the room when a person enters the room and applying the service onto the home network.

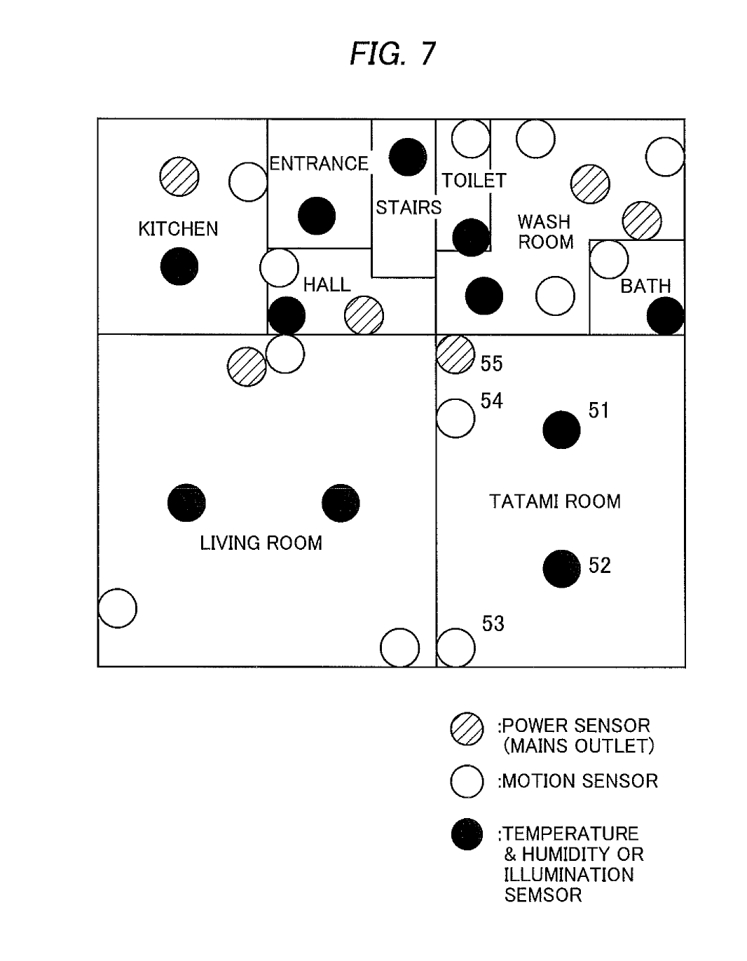

FIG. 7 schematically shows locations of the sensor devices 1-n on the home network according to the preferred embodiment. In the figure, circles with hatching indicate the cooperating sensor, such as a temperature and humidity sensor and an illumination sensor, black circles indicate the action detecting sensor, such as a motion sensor, and white circles indicate an electric power sensor of measuring the electric energy of a mains electricity outlet. Each sensor is arranged at a suitable position in a room.

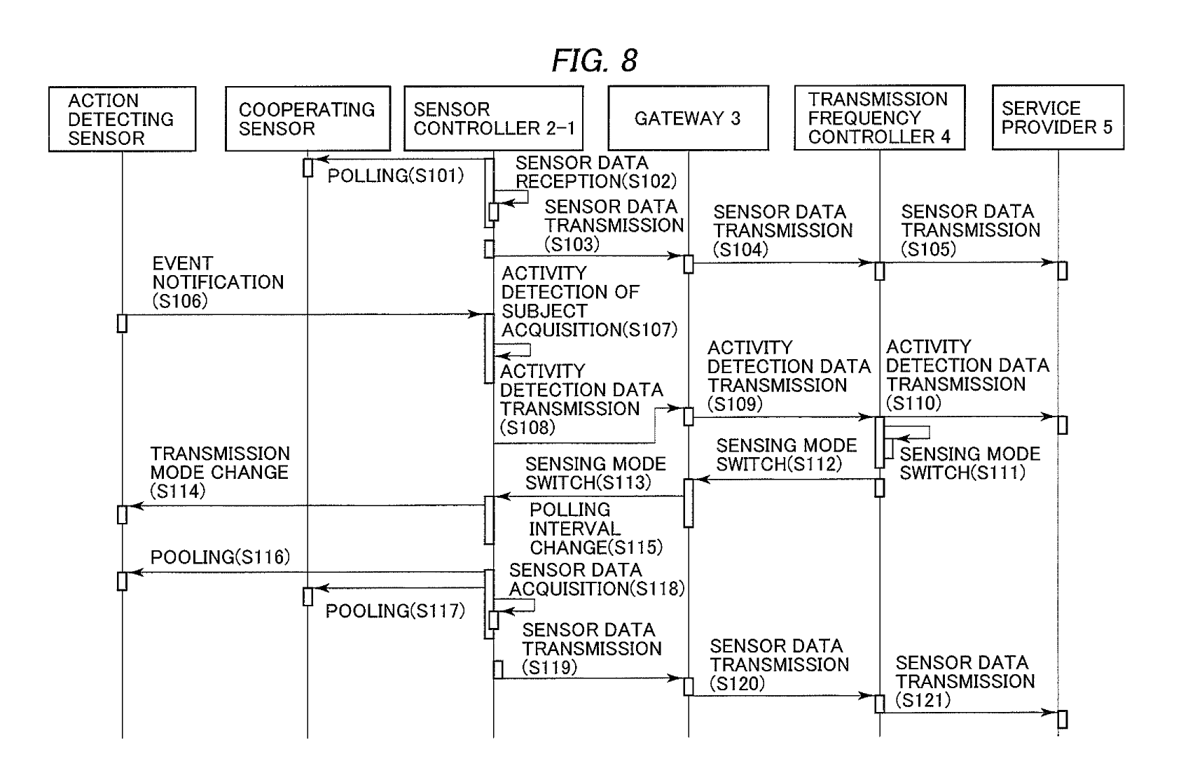

FIG. 8 is a sequence chart useful for understanding the process of controlling a transmission frequency of sensor data over the network 10 according to the preferred embodiment.

In the preferred embodiment, initially, the action detecting sensor applies the event notification mode of notifying the sensor data in response to the event occurrence and the cooperating sensor applies the polling mode of transmitting data in response to the reception of the polling from the sensor controller 2-1. It is to be noted that the action detecting sensors may be prepared in plural.

In FIG. 8, the sensor controller 2-1 transmits polling to the cooperating sensor applying the polling mode at regular intervals by the polling controller 212 (step S101).

In the cooperating sensor, the communication processor 11 receives the polling from the sensor controller 2-1, and then, the polling notifying section 112 transmits sensor data to the sensor controller 2-1. In the sensor controller 2-1, the communication processor 22 receives the sensor data from the cooperating sensor (step S102), and then, transmits the received sensor data via the gateway 3 to the transmission frequency controller 4 (steps S103 and S104).

In the transmission frequency controller 4, the communication processor 41 transmits the regularly received sensor data to the service provider 5 (step S105). The controller 4 then may carry out a predetermined process on the received data and send the processed data to the service provider 5.

Since the action detecting sensor applies the event notification mode, the sensor does not transmit data or notify an event until an event of detecting the subject or person occurs. Therefore, the data according to the event notification of the action detecting sensor is not transmitted onto the local and upper local networks 7 and 8. On the other hand, since the cooperating sensor applies the polling mode, by lengthening the polling interval of the sensor controller 2-1, e.g. to a rate of once per hour before the detection of the subject in the action detecting sensor, it is possible to decrease the data transmission frequency of the sensor controller 2-1 and traffic on the local and upper local networks 7 and 8.

Next, in the action detecting sensor, when the sensor 12 detects the subject, the event notifying section 111 notifies the event with the sensor data indicating the detection of the subject to the sensor controller 2-1 (step S106). After the event occurs, the action detecting sensor transmits data with relatively high frequency.

The sensor controller 2-1 receives the data indicating acquisition of the activity detection of the subject (step S107) and transmits the data or activity detection data from the action detecting sensor via the gateway 3 to the transmission frequency controller 4 (steps S108 and S109). The controller 4 transmits the received data to the service provider 5 (step S110).

In the transmission frequency controller 4, when the communication processor 41 receives data, the situation recognizer 42 refers to the sensor identification included in the data to recognize that the data is transmitted from the action detecting sensor and that the action detecting sensor detects the subject.

Moreover, in the transmission frequency controller 4, when the data reception from the action detecting sensor is recognized, the sensing mode switcher 43 switches the data transmission mode of the sensor from the event notification mode to the polling mode. The sensing mode switcher 43 also refers to the sensor situation information in the sensor situation information storage 45 to identify the cooperating sensors cooperating with the action detecting sensor, and then, changes the polling interval so as to increase the data transmission frequency of the cooperating sensors (step S111).

The change of the polling interval may be performed on the basis of a changing manner prepared in advance. For example, the manner is determined in advance so as to change the data transmission frequency from a slow rate of once per hour to another fast rate of once per minute or a second.

The transmission frequency controller 4 also transmits a sensing mode changing command, i.e. the communication control direction indicating the data transmission mode and the polling interval changed by the sensing mode switcher 43, to the sensor controller 2-1 being communicable with the action detecting sensor and its cooperating sensors (steps S112 and S113).

In the sensor controller 2-1, in accordance with the communication control direction from the transmission frequency controller 4, the controller 21 performs the switch of the data transmission mode of the action detecting sensor and the change of the polling interval of each cooperating sensor.

For instance, the event notification controller 211 commands the action detecting sensor to suspend the event notification and to switch the data transmission mode to the polling mode (step S114). The event notification controller 211 also revises the communication control managing information of the action detecting sensor in the communication control manager 23 to rewrite the item of “data transmission mode” to the polling mode and the item of “polling interval” to a value directed by the transmission frequency controller 4 (step S115).

In addition, the polling controller 112 rewrites the communication control managing information of the cooperating sensor in the communication control manager 23 to rewrite the item of “polling interval” to the value directed by the transmission frequency controller 4.

The sensor controller 2-1 furthermore transmits polling on the basis of the changed polling interval to each sensor device 1-n (steps S116 and S117). The controller then receives sensor data transmitted in response to the polling from the sensor device 1-n (step S118) and transmits the received sensor data via the gateway 3 to the transmission frequency controller 4 (steps S119 and S120). The transmission frequency controller 4 receives the sensor data to collect data from the sensor devices, carries out a predetermined process on the basis of the collected data and transmits the received sensor data and processed data to the service provider 5 (step S121).

Thus, by switching the data transmission mode of the action detecting sensor from the event notification mode to the polling mode, it is possible to decrease the data transmission frequency of the sensor for detecting the subject, thereby decreasing the traffic of needless sensor data on the local and upper local networks 7 and 8.

In addition, when the action detecting sensor detects a subject to be sensed, the polling intervals of its cooperating sensors are shortened to monitor the variation of the sensor data in detail, thereby effectively recognizing the action of the subject by the transmission frequency controller 4. Thus, by decreasing the data transmission frequency for the detection of the subject and increasing the other data transmission frequencies of the surrounding sensor data of the subject, it is possible to acquire only the needed sensor data without increasing the traffic of sensor data.

For instance, in the home network shown in FIG. 7, the motion sensors 51 and 52 are correspondent with the action detecting sensor, and the temperature and humidity and illumination sensors 55 and electric power sensors 53 and 54 are correspondent with the cooperating sensor cooperating with the action detecting sensor.

When the motion sensor 51 or 52 senses entrance of a person or the subject into a tatami room, the motion sensor 51 or 52 sends an event notification with the sensed data to the sensor controller 2-1 not shown in FIG. 7.

Subsequently, the data transmission frequency is controlled as described above with reference to FIG. 8, and therefore, the transmission modes of the motion sensors 51 and 52 are switched from the event notification mode to the polling mode. In addition, the polling interval of the sensor controller 2-1 not shown in FIG. 7 is changed to a value on the basis of the communication control direction from the transmission frequency controller 4 not shown in FIG. 7. The temperature and humidity and illumination sensors 55 and electric power sensors 53 and 54 receive the polling at shortened interval from the sensor controller 2-1 and transmit the sensor data to the sensor controller 2-1 in response to the polling reception.

Thus, when there is a person or subject in the tatami room, it is possible to frequently acquire data required for grasping his or her action, such as electric power data, temperature and humidity data and illumination data. Therefore, for example, to detect that set temperature of the air-conditioner is too high or low, it is possible to change the operating interval of the temperature and humidity sensor 55 from an interval of several minutes to alternative interval of several seconds.

Other sensors in other rooms may be controlled by other sensor controllers 2-m differed from the tatami room. Therefore, data collection by the other sensors in the other rooms may be performed at a low polling frequency or by the event transmission mode, thereby preventing useless traffic from being caused on the network.

Further subsequently, when the motion sensors or action detecting sensors cannot detect a subject, i.e. when the transmission frequency controller 4 does not receive data from the action detecting sensors, the controller 4 directs the sensor controller to change the polling interval of each cooperating sensor to an original polling interval and to switch the transmission mode of the action detecting sensor to the event notification mode.

In summary, according to the preferred embodiment, after the action detecting sensor detects a subject to be sensed, the frequency of transmitting data by the action detecting sensor is decreased and the frequency of sensing data by the cooperating sensors cooperating with the action detecting sensor is increased, thereby collecting only a large volume of needed sensor data to monitor in detail and effectively recognize the action of a subject to be sensed without increasing the traffic on the entire network.

The illustrative embodiment of the sensor data transmission frequency controller is depicted and described as applied onto the network 10 shown in FIG. 1. The network to which the transmission frequency controller is applicable may not be restricted to the configuration as shown in FIG. 1.

For instance, although the preferred embodiment has been described such that the transmission frequency controller is used for a case where the sensor data is received and transmitted via the gateway 3 between a plurality of networks, the controller may be arranged so as to be suited for the use in a single network.

In addition, the arrangements of the components may not be restricted to the configuration specifically shown in FIG. 1. For instance, the service provider 5 is arranged at an inferior position to the global network 9 in the preferred embodiment, but may be arranged on the upper local network 8.

Furthermore, a manner of controlling the transmission frequency of the sensor data may not be restricted to the preferred embodiment. For instance, although the preferred embodiment is described such that the transmission frequency controlling manner according to the transmission frequency controller 4 switches the data transmission mode of the sensor controller 2-m between the polling and event notification modes, the similar effect to the preferred embodiment can be accomplished by using only the polling mode and adjusting, such as lengthening or shortening, the polling interval by the transmission frequency controller 4.

Alternatively, the similar effect to the preferred embodiment can also be attained by using only the event notification mode and adjusting, such as increasing or decreasing, the event threshold by the transmission frequency controller 4.

In addition, when only the event notification mode is used, without arranging the sensor controllers of controlling the sensor devices, the transmission frequency controller may direct the change of the event threshold directly to the sensor devices.

Although the preferred embodiment is also described such that the transmission frequency controller is arranged as one component between the sensor controller and service provider, the arrangement of the transmission frequency controller may not be restricted to such a configuration. It may be sufficient to dispose the transmission frequency controller simply prior to providing sensor data to the service provider, i.e. at any position prior to the service provider. For example, the transmission frequency controller may be installed into the network components, such as the gateway.

To simplify the description, the preferred embodiment classifies the sensors into the action detecting sensor and cooperating sensor. However, the data transmission frequency may not always be decreased for all the cooperating sensors, but the frequencies of only some of the cooperating sensors, such as the particular cooperating sensors required for monitoring data or recognizing situation, can be preferentially increased to the remaining cooperating sensors. Thus, in one cooperating sensors' group, the particular cooperating sensors for sensing data at the high data transmission frequency may be prepared, in addition to the other cooperating sensors for sensing data at the low data transmission frequency. Moreover, separate data transmission frequencies may be determined for the respective cooperating sensors.

The processing according to the transmission frequency controller may be implemented by software. The transmission frequency controller comprises a variety of computer resources, for example, an operating unit, such as a microcomputer or a CPU (Central Processing Unit), or memories, such as RAM (Random Access Memory), ROM (Read-Only Memory) and EEPROM (Electrically Erasable Programmable Read-Only Memory). The processing of the transmission frequency controller is implemented by executing a program stored in secondary storage with required data for the processing by the CPU.

The entire disclosure of Japanese patent application No. 2010-250010 filed on Nov. 8, 2010, including the specification, claims, accompanying drawings and abstract of the disclosure, is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A transmission frequency controller for controlling transmission frequencies of sensor data, at which frequencies a plurality of sensor devices respectively transmit sensed data, comprising:
situation information storage for storing respective situation information of the plurality of sensor devices, which consist of subject detecting sensor devices of detecting a subject and one or more cooperating sensor devices cooperating with the subject detecting sensor device, which information clarifies an association of the cooperating sensor device with the subject detecting sensor device; and
a transmission frequency changing director for directing change of a data transmission frequency in accordance with the subject detecting data received from the subject detecting sensor device to the subject detecting sensor device confirmed by referring to the situation information and the cooperating sensor device cooperating with the subject detecting sensor device.

2. The transmission frequency controller in accordance with claim 1, wherein
the situation information includes information of a sensor controller of controlling communication with the sensor devices, and
the transmission frequency changing director directs change of a polling interval or event threshold used for data transmission to the sensor controller of controlling the cooperating sensor device by referring to the situation information.

3. The transmission frequency controller in accordance with claim 1, wherein
the transmission frequency changing director directs switch of a data transmission mode used for data transmission to the subject detecting sensor device and the cooperating sensor device in accordance with a subject detecting situation based on the subject detecting data received from the subject detecting sensor device.

4. A recording medium having a computer program recorded thereon, wherein said computer program, when running on a computer, functioning as a transmission frequency controller for controlling transmission frequencies of sensor data on a network, at which frequencies a plurality of sensor devices respectively transmit sensed data, wherein
the computer comprises:
situation information storage for storing respective situation information of the plurality of sensor devices, which consist of subject detecting sensor devices of detecting a subject and one or more cooperating sensor devices cooperating with the subject detecting sensor device, which information clarifies an association of the cooperating sensor device with the subject detecting sensor device; and
said program makes the computer work as
a transmission frequency changing director for directing change of a data transmission frequency in accordance with the subject detecting data received from the subject detecting sensor device to the subject detecting sensor device confirmed by referring to the situation information and the cooperating sensor device cooperating with the subject detecting sensor device.
